(19) United States
(12) Patent Application Publication
(10) Pub. No.: US 2025/0052630 A1
(43) Pub. Date: Feb. 13, 2025

(54) IMPACT DETECTION SYSTEM

(71) Applicant: A-SAFE HQ LTD, Elland Yorkshire (GB)

(72) Inventor: Matthew WROE, Elland Yorkshire (GB)

(21) Appl. No.: 18/722,615

(22) PCT Filed: Dec. 22, 2022
(86) PCT No.: PCT/GB2022/053362

§ 371 Date: Jun. 21, 2024

(30) Foreign Application Priority Data
Dec. 23, 2021 (GB) 2118934.5

(51) Int. Cl. G01L 5/00; G08B 21/18

(52) U.S. Cl. CPC G01L 5/0052; G08B 21/18

(57) ABSTRACT

An impact detection system includes: a memory configured to store at least one property of a structure; a sensor unit configured to detect movement of the structure and to generate movement data; and a processor configured to: receive the movement data from the sensor unit; determine, based on the movement data, whether an impact to the structure has occurred; and determine, based upon determining that the impact has occurred, the information about the impact based on the movement data and the at least one property of the structure.

### CROSS REFERENCE TO RELATED APPLICATIONS

This application is a U.S. National Phase application under 35 U.S.C. § 371 of International Application No. PCT/GB2022/053362, filed on Dec. 22, 2022, and claims benefit to British Patent Application No. GB 2118934.5, filed on Dec. 23, 2021. The International Application was published in English on Jun. 29, 2023 as WO 2023/118881 A1 under PCT Article 21(2).

### FIELD

The present disclosure relates to an impact detection system.

### BACKGROUND

In a factory or warehouse environment, vehicles such as forklift trucks may be required to move within confined spaces and in close proximity to goods and personnel. When maneuvering around these confined spaces, vehicles may, on occasion, impact racking units containing goods. This may cause damage to the racking units such that the racking units may be susceptible to collapse.

Barrier systems may be provided in a factory or warehouse environment to limit damage from vehicles. Barrier systems may be formed of a network of posts with connecting members such as rails to connect the posts.

A sensor system may detect and report collisions of vehicles with structures. However, the present inventor has recognized that such conventional sensor systems may generate false alarms from non-damaging collisions with structures.

### SUMMARY

In an embodiment, the present disclosure provides an impact detection system that includes: a memory configured to store at least one property of a structure; a sensor unit configured to detect movement of the structure and to generate movement data; and a processor configured to: receive the movement data from the sensor unit; determine, based on the movement data, whether an impact to the structure has occurred; and determine, based upon determining that the impact has occurred, the information about the impact based on the movement data and the at least one property of the structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of an example impact detection system;

FIG. 2 is a schematic illustration of another example impact detection system;

FIG. 3 is a schematic illustration of the impact detection system connected to a structure of a barrier system;

FIG. 4 is a schematic illustration of a barrier system;

FIG. 5 is a schematic illustration of an example impact detection system; and

FIG. 6 is an illustration of the impact detection system connected to a racking unit.

### DETAILED DESCRIPTION

According to a first aspect of the present disclosure, there is provided an impact detection system comprising: a memory to store at least one property of a structure; a sensor unit to detect movement of the structure and generate movement data; a processor to receive the movement data from the sensor unit, and to determine, based on the movement data, whether an impact to the structure has occurred. When it is determined that an impact has occurred, the processor is configured to determine information about the impact based on the movement data and the at least one property of the structure.

The use of at least one property of the structure in addition to the movement data may improve the reliability or accuracy of impact detection.

The structure may be structure susceptible to damage, for example within a warehouse environment. The structure may be a safety structure, such as an element of a barrier system. The structure may be an element of a racking unit, such as a leg or shelf of a racking unit.

The impact detection system may be configured to output the determined information about the impact, for example to a central monitoring system. The impact detection system may thereby provide information to a user regarding damage occurring from an impact, which may indicate that the structure needs to be repaired or replaced.

The information about the impact may comprise at least one of a severity of the impact, a direction of the impact, a probability of damage to the structure and an estimated change in expected lifetime of the structure in response to the impact. The user may thereby be able to monitor when a structure requires replacement, for example when a severity of impact is high, when a probability of damage is high, and/or when an end of expected lifetime of the structure is approaching.

The sensor unit may be configured to detect at least one of acceleration of the sensor unit, a time of the movement, the temperature of the structure, the moment of inertia of the sensor unit, a sound of the impact and a magnetic change as the movement data.

The processor may be configured to determine at least one of the velocity of the sensor system and the displacement of the sensor based on the movement data. The processor may be configured to determine a velocity of the impact, a position of the impact, an energy of the impact, a displacement of the structure, and a number of impacts based on the movement data and the at least one property of the structure.

The at least one property of the structure may comprise at least one of Young's modulus, yield strength, and/or one or more dimensions of the structure. These properties may provide improved accuracy in the information about the impact. For example, a material with a high Young's modulus may be more likely to fracture upon application of the same impact force than a material with a low Young's modulus.

The sensor unit may be provided in a housing. The housing may be attachable to the structure. In another example, the housing may be configured to be formed integrally with and within the structure.

The sensor unit may comprise at least one of an accelerometer, a thermometer, a proximity detector, a magnetometer and a microphone.

The impact detection system may further comprise the structure.

The structure may be a connecting member and/or a post of a barrier system. The connecting member may be a rail.

The structure may be made from a polymer.

The structure may be an element of a racking unit, such as a leg or shelf of the racking unit.

The impact detection system may comprise a plurality of the sensor units in communication with the processor. Each of the sensor units may be configured to detect movement of a respective structure in a network of structures. The processor may be configured to receive the movement data from the plurality of sensor units and determine, based on the movement data, whether the detected movement indicates an impact to one or more structures.

Each of the sensor units may be configured to detect movement of a respective structure in a barrier system, wherein the barrier system is formed of a network of structures and wherein the structures are posts and at least one connecting member. The processor may be configured to determine whether the detected movement indicates an impact to one or more of the posts and/or the at least one connecting member.

Each of the sensor units may be configured to detect movement of a respective structure of a racking unit, wherein the respective structures may be connected. The processor may be configured to determine whether the detected movement indicates an impact to one or more of the structures of the racking unit.

The memory and the processor may be provided on a server that is remote to the plurality of sensor units.

The memory may be configured to store network information, wherein the network information includes the number of structures and their relative location, the type of structure and how the structures are connected, for example whether a post of a barrier system is connected to another post by a connecting rail or whether a post of a barrier system is a standalone post. The memory may be further configured to store at least one property of the plurality of structures.

When a movement of a structure is detected, the processor may be configured to determine which one or more of the structures is impacted and which one or more of the structures is deflected by its connection to an impacted structure, based on the movement data and the network information.

The processor may be configured to determine the probability of damage to the structures using the network information and information about the impact.

The processor may be configured to update a database of conditions of the structures in the network according to the determined probability of damage.

When an impact is detected, the system may be configured to generate an alert, wherein the alert indicates at least one of a location of the impact, a severity of the impact, and a probability of damage to one or more of the structures.

The alert may be at least one of a visual alert on one or more of the structures and a visual alert on an a map of the network, displayed on a user interface.

According to another aspect, there is provided a machine-readable storage medium comprises instructions which, when executed by a computer, cause the computer to: receive movement data associated with movement of a structure from a sensor unit; determine, based on the movement data, whether an impact to the structure has occurred; and when it is determined that an impact has occurred, determine information about the impact based on the movement data and at least one property of the structure.

Although a few preferred embodiments of the present disclosure have been shown and described, it will be appreciated by those skilled in the art that various changes and modifications might be made without departing from the scope of the invention, as defined in the appended claims.

For a better understanding of the present disclosure, and to show how embodiments of the same may be carried into effect, reference will now be made, by way of example only, to the accompanying diagrammatic drawings.

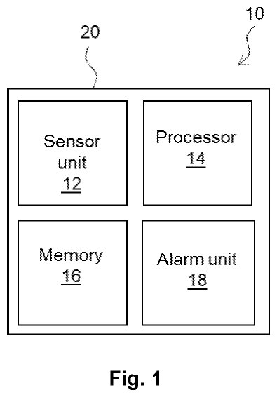

FIG. 1 shows an impact detection system 10 that includes a sensor unit 12, a processor 14, and a memory 16. The sensor unit 12 comprises one or more sensors and is configured to communicate with the processor 14.

The sensor unit 12 comprises at least one movement sensor, for example an accelerometer, and is configured to detect movement of a structure. The sensor unit 12 is configured to transmit movement data corresponding to the detected movement to the processor 14. The processor 14 is configured to determine whether the detected movement is a result of an impact to the structure based on the movement data.

The sensor unit 12 may comprise a plurality of sensors. For example, the sensor unit 12 may comprise at least one of a microphone, a temperature sensor and a magnetometer, in addition to the movement sensor.

In an example, wherein the sensor unit 12 comprises an accelerometer configured to measure acceleration, the processor 14 is configured to calculate the velocity and displacement of the movement based on acceleration measurements received from the sensor unit 12 and the processor 14 may determine that an impact has occurred based on displacement and/or the velocity exceeding a predetermined threshold. For example, the processor 14 compares the measured displacement to a predetermined threshold displacement and determines that an impact has occurred when the displacement is greater than the predetermined threshold displacement. Additionally or alternatively, the processor 14 compares the velocity of the movement to a predetermined threshold and determines that an impact has occurred when the velocity of the movement is greater than the predetermined threshold velocity.

In an example, wherein the sensor unit 12 comprises a microphone, the processor 14 is configured to determine whether an impact has occurred based on a detected sound data associated with a movement.

The memory 16 stores at least one property of the structure. The memory 16 may store at least one physical property of the structure, such as the at least one of a mass of the structure, dimensions of the structure, a moment of inertia of the structure, a Youngs modulus of the structure, a yield strength of the structure.

When it is determined by the processor 14 that an impact has occurred to the structure, the processor 14 is configured to determine information about the impact based on the at least one property of the structure and the measured movement data.

The information about the impact may be at least one of a force of the impact, the energy of the impact, the position of the impact, the displacement of the structure and the number of impacts. The processor 14 is configured to calculate at least one of a force of the impact, the energy of the impact, the position of the impact, the displacement of the structure and the number of impacts, based on the calculated velocity and displacement of the sensor unit and the at least one property of the structure, and optionally the temperature of the structure. For example, for different materials and temperature of a structure, the applied force required to provide the same amount of movement of the structure may be different.

The information about the impact may include a severity of the impact. Based on the calculated at least one of a force of the impact, the energy of the impact, the position of the impact, the displacement of the structure and the number of impacts, the processor 14 determines the severity of the impact to the structure. The processor 14 may determine a severity score, which may be a function of the velocity of the impact, the position of the impact, the energy of the impact, the displacement of the impact, the number of impacts and the temperature of the structure. The temperature of the structure may be determined based on data provided by the temperature sensor provided in the sensor unit 12. The processor 14 may classify the impact based on the severity, for example, as low, medium or high severity.

The information about the impact may include a probability of damage to the structure. Based on the calculated at least one of a force of the impact, the energy of the impact, the position of the impact, the displacement of the structure and the number of impacts, the processor 14 determines the probability of damage to the structure. The probability of damage may be a function of the velocity of the impact, the position of the impact, the energy of the impact, the displacement of the impact, the number of impacts and the temperature of the structure. The processor 14 may classify the probability of damage as low, medium or high probability of damage.

In an example, the processor 14 is configured to determine a change in expected lifetime of the structure based on the information. For example, the processor 14 may be configured to determine a change in expected lifetime of the structure based on at least one of the probability of damage and the severity of the impact.

The processor 14 generates an updated expected lifetime of the structure based on the determined change in expected lifetime and a previously stored lifetime of the structure from the memory 16. An updated expected lifetime may be stored in the memory 16 based on the change in expected lifetime.

The memory 16 stores a condition of the structure. The processor 14 is configured to determine an updated condition of the structure based on the information about the impact and the updated condition is stored in the memory 16. The impact detection system 10 may be configured to monitor the condition of structure.

The system is configured to output information about the impact. In some examples, as shown in FIG. 1, the system comprises an alarm unit 18. The processor 14 is configured to control the alarm unit 18 to output an alarm based on the determined information, for example based on the severity of impact. For example, the processor 14 is configured to control the alarm unit 18 to output an alarm when the processor 14 determines that the severity of the impact is high or the likelihood of damage of the impact is high. In another example, the processor 14 is configured to control the alarm unit 18 to output an alarm when the processor 14 determines that the condition of the structure is below a predetermined requirement, for example to indicate that the structure requires repair or replacement.

The alarm unit 18 is configured to output an audible alarm, such as a siren and/or outputs a visible alarm, such as a flashing light. The alarm unit 18 thereby provides an indication that an impact has occurred, and where the impact has occurred.

The sensor unit 12 is provided in a housing 20. In some examples, as shown in FIG. 1, the alarm unit 18 is provided in the housing 20.

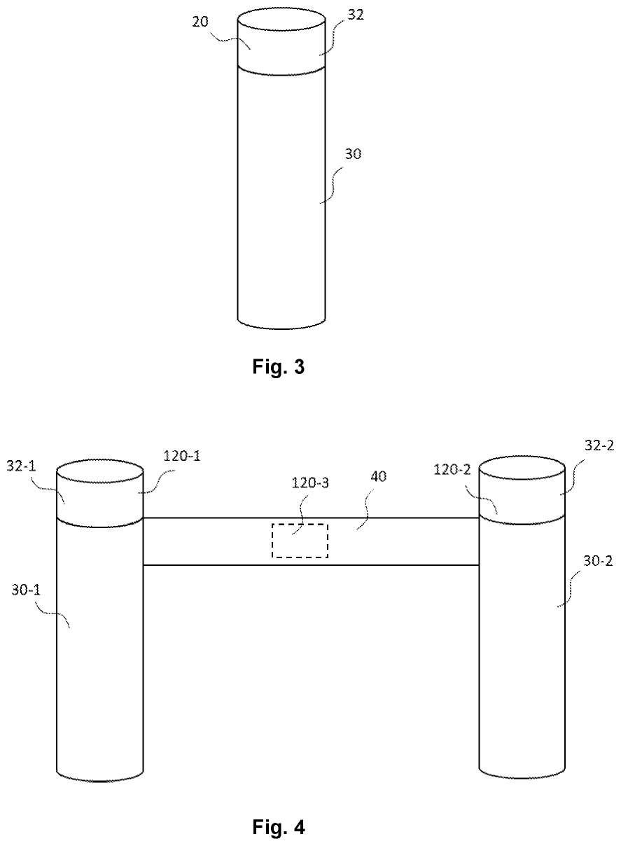

The impact detection system 10 is configured to be connected to a structure in use. For example, the housing 20 may be attachable to the structure. The structure may be a post or a rail of a barrier system. FIG. 3 shows an example of the housing 20 containing the sensor unit 12 attached to a post 30, wherein the housing 20 forms a cap 32 of the post 30.

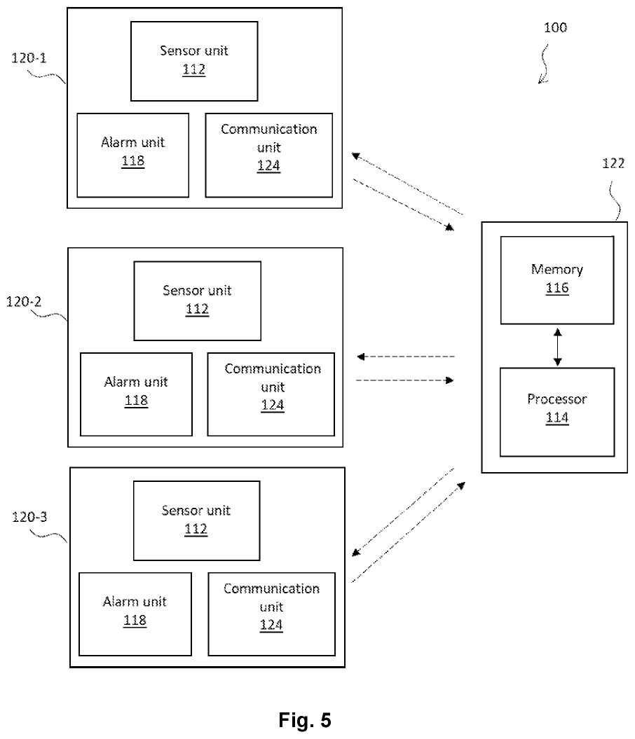

In another example, the housing 20 may be integrated with and within the structure. FIG. 4 shows an example wherein the housing 120-3 is integrated within a rail 40 of a barrier system.

In other examples, the housing containing the sensor unit may be attached to or integrated within other structures within a factory or warehouse environment, such as machine guarding or dock gates.

In some examples, the processor 14 and memory 16 are housed in the housing 20, such that the impact detection system 10 is self-contained with the housing 20, as shown in FIG. 1.

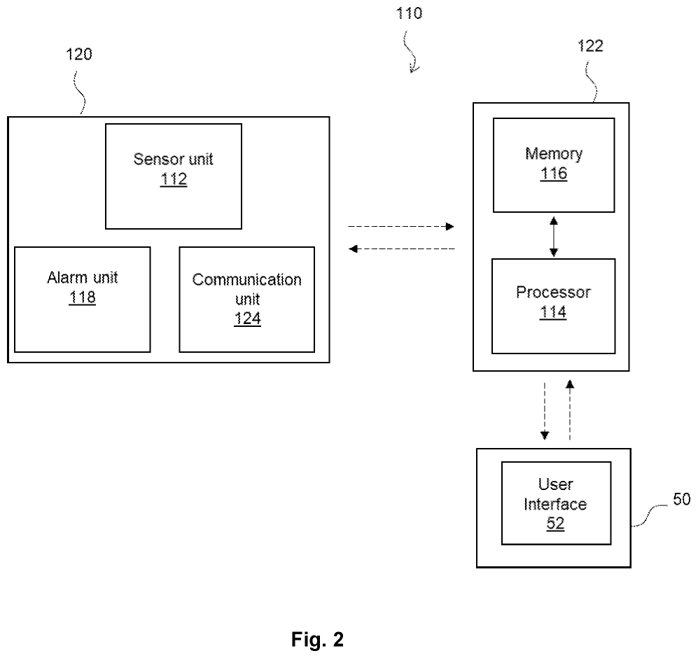

In other examples, the processor and memory are located remotely from the sensor unit. For example, in the impact detection system 100 shown in FIG. 2, the memory 112 and processor 114 are provided on a remote server 122 and a communication unit 124 is provided in the housing 120 and is configured to communicate with the remote server 120. The communication module 124 is configured to communicate wirelessly with the remote server 122. In other examples, the communication unit 124 may be configured to communicate with the server 122 by a wired connection. In some examples, the remote server 122 is a cloud platform and the memory 114 is a database in the cloud platform. The processor 114 may be configured to perform any or all of the functions of the processor 14 described above.

In some examples, the processor may comprise a plurality of processors, a first processor being provided in the housing and the second processor being provided on the remote server. The functions of the processor described herein may be performed locally to the housing and/or may be performed remotely from the housing.

In the example shown in FIG. 2, the impact detector system 100 is configured to transmit a signal to an external device such as an electronic device 50. The signal is transmitted from the remote server 122. In an example, the signal comprises the determined information and the electronic device determines whether to display an alert based on the determined information. In another example, the signal comprises instructions for displaying an alert. The electronic device 50 comprises a user interface 52 configured to display the alert. For example, the user interface 52 may indicate that the structure should be inspected or repaired based on the severity of the impact and/or probability of damage. The processor 114 may transmit a signal to the electronic device to schedule maintenance of the structure based on the determined information about the impact and upon receiving the signal the user interface may output a notification to a user to schedule maintenance of the structure.

A barrier system, for example as shown in FIG. 4, comprises a plurality of posts 30-1, 30-2 and one or more connecting rails 40. FIG. 4 shows an example wherein a barrier system comprises one connecting rail 40 and two posts 30-1, 30-2, however in other examples the barrier system may comprise any number of connecting rails and rails. Not all posts may necessarily be connected to other posts by rails, for example in some barrier systems may comprise connected posts and one or more stand-alone posts.

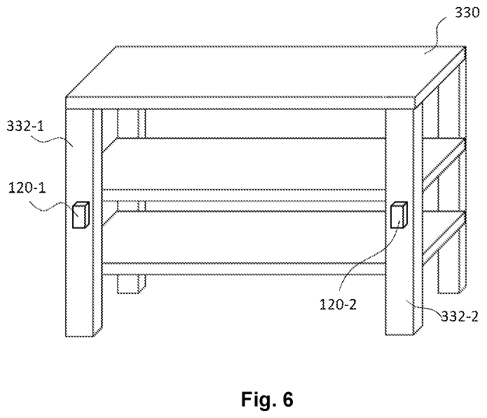

FIG. 6 shows a racking unit 330 wherein a first sensor housing 120-1 containing a sensor unit is attached to a first leg 332-1 of the racking unit 330 and a second sensor housing 120-2 containing a sensor unit is attached to a second leg 332-1 of the racking unit 330. FIG. 6 shows an example wherein sensor housings are connected to two legs of the racking unit, however in other examples, sensor housings may be connected to may be connected to any number of legs and/or shelves of a racking unit or a plurality of racking units.

FIG. 5 is a schematic of an impact detection system 200 formed of a plurality of sensor housings 120-1, 120-2, 120-3, which each house a sensor unit 112, an alarm unit 118 and a communication unit 120. The sensor housings 120-1, 120-2, 120-3 are configured to be connected to a network of structures in a barrier system, for example as shown in FIG. 4. In other examples, the sensor housings 120-1, 120-2, 120-3 are configured to connected to a network of structures in a racking unit. It will be appreciated that in some examples the number of sensor unit housings 120 may be less than or greater than three. For example, sensor housings 120-1, 120-2 are configured to be connected to a racking unit 330 as shown in FIG. 6.

In the example shown in FIG. 5, the communication units 124 in the plurality of sensor unit housings 120-1, 120-2, 120-3 are configured to communicate with the remote server 122 comprising the processor 114 and memory 116. Each communication unit 124 is configured to transmit the movement data to the processor 114. It will be appreciated that a processor may also be provided in the sensor unit housings 120 and in such examples, the communication units 124 may be configured to transmit processed movement data to the processor 114, for example determined information about an impact.

The memory 116 is configured to store information of the relative location of the sensor unit housings 120-1, 120-2, 120-3, the type of structure to which each sensor unit housing 120-1, 120-2, 120-3 is connected, for example a post or a rail of a barrier system, and how the structures are connected.

In a barrier system, although one structure may be impacted by a vehicle, other connected structures that are not impacted but are deflected due to their connection to the impacted structure may also be damaged. For example, if the post 30-2 shown in FIG. 4 is impacted, the rail 40 may be deflected and may be damaged. Similarly, in a racking unit, although one leg of a racking unit may be impacted, other connected structures such as shelves or other legs may also be damaged. For example, if the leg 332-1 of the racking unit 330 shown in FIG. 6 is impacted, the leg 332-2 may be deflected and may be damaged. The sensor units 112 connected to the deflected structures may generate movement data corresponding to the impact.

The processor 114 is configured to receive the movement data and is configured to determine whether a structure has been impacted or whether the structure has been deflected due to the impact. In an example, the processor 114 compares the movement data received from the plurality of sensor units 112 and determines which of the structures is impacted and which of the structures is deflected based on the comparison.

The processor 114 is configured to determine information about the impact based on the received movement data, based on the property of the structures and based on network information. For example, the probability of damage to a structure may be greater if the structure is a standalone post or a corner post of a barrier system, and may be lower if the structure is connected to other posts of a barrier system by rails.

In an example, the user interface 52 is configured to display a map of the plurality of structures. The processor 114 is configured to transmit instructions to the electronic device 50 to display an alert. The instructions include a location of the damaged structure and the user interface 52 is configured to display an alert indicating the location of the damaged structure on the map.

The impact detection system according to the present disclosure may provide improved reliability and accuracy in determining whether an impact has occurred and determining severity of the impact, probability of damage to the impacted structure and/or change to expected lifetime of the structure based on movement data and at least one property of the structure. Maintenance or repair may thereby be scheduled at an appropriate time based on the determined information. The impact detection system may also provide information on probability of damage to structures connected to impacted structures, which may also require repair or replacement. The user may be able to readily recognize which structures in a system require maintenance based on the output of the impact detection system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An impact detection system, the impact detection system comprising:
a memory configured to store at least one property of a structure;
a sensor unit configured to detect movement of the structure and to generate movement data; and
a processor configured to:
receive the movement data from the sensor unit;
determine, based on the movement data, whether an impact to the structure has occurred; and
determine, based upon determining that the impact has occurred, the information about the impact based on the movement data and the at least one property of the structure.

2. The impact detection system according to claim 1, wherein the information about the impact comprises at least one of: a severity of the impact, a direction of the impact, a probability of damage to the structure, or an estimated change in expected lifetime of the structure in response to the impact.

3. The impact detection system according to claim 1, wherein the sensor unit is further configured to detect at least one of: acceleration of the sensor unit, a time of the movement, a temperature of the structure, a moment of inertia of the sensor unit, a sound of the impact, or a magnetic change as the movement data.

4. The impact detection system according to claim 1, wherein the processor is further configured to:
determine at least one of: a velocity of the sensor system or a displacement of the sensor unit based on the movement data, and
determine a velocity of the impact, a position of the impact, an energy of the impact, a displacement of the structure, and a number of impacts based on the movement data and the at least one property of the structure.

5. The impact detection system according to claim 1, wherein the at least one property of the structure comprises at least of: Young's modulus, yield strength, and/or one or more dimensions of the structure.

6. The impact detection system according to claim 1, wherein the sensor unit is in a housing, and wherein the housing is attachable to the structure.

7. The impact detection system according to claim 1, wherein the sensor unit is in a housing and the housing is formed integrally with the structure.

8. The impact detection system according to claim 1, wherein the sensor unit comprises at least one of: an accelerometer, a thermometer, a proximity detector, a magnetometer, and a microphone.

9. The impact detection system according to claim 1, further comprising the structure.

10. The impact detection system according to claim 9, wherein the structure is made from a polymer.

11. The impact detection system according to claim 1, further comprising a plurality of the sensor units in communication with the processor,
wherein each of the sensor units is configured to detect movement of a respective structure,
wherein the processor is further configured to receive the movement data from the plurality of sensor units and to determine, based on the movement data, whether the detected movement indicates an impact to one or more of the structures.

12. The impact detection system according to claim 11, wherein the memory and processor are on a server that is remote to the plurality of sensor units.

13. The impact detection system according to claim 10, wherein the memory is configured to store network information, wherein the network information comprises the number of structures and their relative location and how the structures are connected.

14. The impact detection system according to claim 13, wherein the processor is further configured to determine, based upon detecting a movement of one or more of the structures, which one or more of the structures is impacted, and which one or more of the structures is deflected due to its connection to an impacted structure, based on the movement data and the network information.

15. The impact detection system according to claim 11, wherein the memory is further configured to store at least one property of each of the plurality of structures.

16. The impact detection system according to claim 15, wherein the processor is further configured to determine information about the impact from the movement data received from the plurality of sensor unis and the at least one property of each of the plurality of structures, and wherein the processor is further configured to determine the probability of damage to one or more of the structures using the network information and the determined information about the impact.

17. The impact detection system according to claim 16, wherein the processor is further configured to update a database of conditions of the structures according to the determined probability of damage.

18. The impact detection system according to claim 11, wherein the system is configured to generate an alert, based upon detecting the impact, wherein the alert indicates at least one of a location of the impact, a severity of the impact, or a probability of damage to one or more of the structures.

19. The impact detection system according to claim 18, wherein the alert is at least one of: a visual alert on one or more of the structures, an audible alert on one or more of the structures, or a visual alert on an a map of the network, displayed on a user interface.

20. A non-transitory machine-readable storage medium comprising instructions which, when executed by a computer, cause the computer to:
receive movement data associated with movement of a structure from a sensor unit;
determine, based on the movement data, whether an impact to the structure has occurred; and
determine, based on determining that the impact has occurred, information about the impact based on the movement data and at least one property of the structure.
